(19) United States
(12) Patent Application Publication
(10) Pub. No.: US 2014/0272917 A1
(43) Pub. Date: Sep. 18, 2014

(54) GLASS NON-GLARE MARKER BOARD

(71) Applicant: GLASS UNLIMITED OF HIGH POINT, INC., High Point, NC (US)

(72) Inventors: John D. Hall, Winston-Salem, NC (US); Tammy Guyton Michael, Thomasville, NC (US)

(73) Assignee: Glass Unlimited of High Point, Inc., High Point, NC (US)

(21) Appl. No.: 13/800,409

(22) Filed: Mar. 13, 2013

(51) Int. Cl. B43L 1/00

(52) U.S. Cl. CPC B43L 1/00
USPC 434/408; 427/162

(57) ABSTRACT

An improved marker board with a glass substrate, a writing surface, and a rear surface. The writing surface roll coated or screen printed with a ceramic frit that is fired into the writing surface. An opaque ink is disposed on the rear surface. The ceramic frit provides glare reduction in high light environments, while maintaining ease of erasability and avoidance of ghosting.

### FIELD OF INVENTION

The present disclosure relates to writing boards having an easily erasable surface. More particularly, the present disclosure is related to glass writing boards with glare control.

### BACKGROUND

Classrooms and conference rooms have long been home to writing boards of various designs. Slate or imitations thereof were used to provide a dark, greenish or black surface on which chalk could be written. The dark background provided a contrast to help the viewer recognize the writing and the slate surface provided substantial roughness to accept and temporarily retain the caulk. These slate chalkboards had their disadvantages, including the mess created by the chalk dust or the scratching noise created when the chalk, or fingernails, was run across the writing surface.

To replace these original chalkboards, dry-erase markers were developed to write on white boards formed from resin or a substrate coated with resin. The white color of these boards, combined with their relatively smooth texture creates a problem with glare in a highly lighted environment. Ambient light is reflected off of the writing surface, significantly reducing contrast and making the writing on the marker board hard to read. High glare environments are on the rise, classroom and office spaces are now much more likely to be configured with the use of natural, bright sunlight, in mind.

### SUMMARY

The inventors propose a glass writing board for use with dry-erase, “permanent,” or water cleanable markers having an improved, substantially smooth, writing surface. The improved writing surface provides increased erasability, eliminates ghosting, and significantly reduces glare. This surface is created by screen printing or roll-coating the writing surface with a coating of zinc based ceramic fit that is baked onto the glass, in order to avoid being scratched off. The light coating should be between 0.5 to 1.5 mil wet coat thickness.

The glass writing board further includes an opaque ink applied to the rear surface of the board, opposite the writing surface, to provide opacity to the glass substrate and to obscure the writing board's mounting surface.

### BRIEF SUMMARY OF THE DRAWINGS

FIG. 1 shows a front perspective view of a marker board according the present disclosure.

FIG. 2 shows a cross sectional view of the marker board of FIG. 1.

### DETAILED DESCRIPTION OF THE DRAWINGS

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention. Features from one embodiment or aspect may be combined with features from any other embodiment or aspect in any appropriate combination. For example, any individual or collective features of method aspects or embodiments may be applied to apparatus, product or component aspects or embodiments and vice versa.

Referencing the Figures generally, the proposed marker board 1 includes a monolithic glass substrate 2 that is coated on both sides to form a first, low glare, writing surface 3 and a second, opaque, surface 4. The glass substrate 2 is float glass wherein the first surface 3 is the air-side of the float glass and the second surface 4 is the tin-side of the float glass. The glass substrate 2 can be cut to specified sizes as requested by the purchaser. The glass substrate 2 can have a variety of thicknesses, but preferably will have a thickness in the range of about 3 mm to about 6 mm. The term “float” glass is utilized, because that is currently the type of glass commonly available today. If glass formed by other processes becomes available it could be used. When using float glass, it is necessary to identify and use the air side as the surface of the marker board to be used for coating with the zinc based ceramic frit. The air-side is opposite the tin-side, where tin-side is defined as the side of the glass ribbon that “floats” on the tin bath during its manufacture.

The first surface 3 of substrate 2 is the intended to be the writing surface of the marker board 1. The first surface 3, after coating, provides a low glare surface due to the application of zinc based ceramic frit layer 31. The zinc based ceramic frit is void of any components that cause dispersion of light. The zinc based frit has shown to have improved clarity and transparency. Other ceramic frits, such as bismuth based ceramic fits, have colorants that disperse light, promoting glare. The zinc based frit provides a higher gloss finished surface, increasing erasability and reducing ghosting compared to surface coating that include colorant. Although zinc based ceramic fit is used in the preferred embodiment, other ceramic frit that lacks light dispersing colorant may be used.

In order to provide the proper bond between the frit layer 31 and the first surface 3, it is important that the first surface 3 is the air-side of the glass substrate 2, free from tin contaminants, dust and dirt particles. If one were to coat the tin side of the glass with the ceramic frit ink, here would occur a darkish brown tinting of the fit, which is undesirable.

The first, or writing, surface 3 may be may be formed using a roll coat process. First, the zinc borosilicate frit is dispersed in a water-soluble miscible, with the zinc borosilicate making up, by weight, 60-80% of the coating. The fit is mixed with the solute to produce a viscosity range between about 15 and about 18 on a Brookfield viscometer using a #6 spindle with a 10 to 0.5-ratio speed. The viscosity of between 15 and 18 is necessary to promote flow through the coater and filter to allow even distribution and cover of the coating.

To begin the coating process, the glass substrate 2 is loaded into the coating machine with the first or writing surface up, the air-side having been determined using short wave ultraviolet light. The coating is then applied with a round, fifty-four inch, forty-durometer rubber compound roller that is grooved to sixty LPI with an approximate wet film lay down of about 0.5 mil to about 0.75 mil. The use of a sixty LPI roller allows for the application of the thin, smooth coating of miscible necessary to produce the desired non-glare writing surface 3. In a preferred embodiment, the doctor roll has a speed of about 0.7 meters per minute, the application roll has a speed of about five meters per minute and the machine belt has a speed of about 4.5 to about 5 meters a minute.

The writing surface 3 may alternatively be applied using a screen print process. First, the application screen is prepared. The application screen is made under normal stretching and pre-use parameters. The screen then has a 3/3 coat of photosensitive emulsion applied and is then placed in a low temperature oven to pre-cure fifteen minutes. Once the emulsion is dry to the touch it is extracted from the oven and placed on the process table for attachment of the predetermined pattern. The screen, with pattern attached, is then exposed on a light table for seven and a half minutes to completely cure the exposed emulsion. The screen is taken to the washout area after exposure and washed with water using a low-pressure hose. The screen is washed until the water runs clear to ensure any non-cured emulsion is washed away. It is then vacuumed of excess water and placed in a low temperature oven to dry the emulsion so that is ready for final touch up and taping and will offer protection from squeegee and flood-bar use as well as cleaning when the production run is completed.

Second, the zinc borosilicate frit is dispersed in a water-soluble miscible, with the frit making up, by weight, 60-80% of the coating. The fit and the solute are mixed to provide aviscosity range between about 20 and about 23 on a Brookfield viscometer using a #6 spindle with a 10 to 0.5-ratio speed. A viscosity between about 20 and about 23 will insure that the coating material does not leak through the mesh onto the substrate 2 before the print process is preformed, where leaking would result in a bad print.

Third, the glass substrate 2 is loaded into a flat bed printer with the first or writing surface up, the air-side having been determined using short wave ultraviolet light. The flat bed printer preferably comprises a 280-thread count mesh screen. Using this higher count mesh provides the unique layer of coating that allows the writing surface 3 to be low glare. The print process further comprises using a 70-durometer flat profile squeegee and either a 95-durometer rubber compound flood bar with a 45 degree bevel tip or a stainless steel flood bar with a 60 degree angle tip.

Fourth, the printer applies a wet coat laydown with a thickness between about 1.0 and about 1.25 mil.

After applying the wet coating using either the roll coating or screen printing method discussed above, the substrate 2 travels through a dryer on a conveyor set to 98° C., with a speed of four meters a minute, for pre-cure. This pre-cure is what makes the first surface 3 easily handled for further processing. When the substrate 2 exits the conveyor it is stacked onto a skid with ink coat 31 facing into the rack. The glass substrate 2 is then secured and moved to the location for frit firing (baking), to adhere the frit to the substrate 2.

The glass substrate 2 is loaded with the coating 31 face up. The glass 2 is loaded according to size and shape for greatest capacity of the oven. The oven temperature is set to 600° C. Heating time and quench time vary depending on the thickness of the glass 2 being processed. During this process, the solvent is burned away leaving only the zinc borosilicate bonded to the glass substrate 2. After firing, the coating layer 31 is not scratchable or removable from the glass substrate 2, even when shattered. The glass 2 is stacked with the ink coating layer 31 facing inside to await the next process. The firing process can be designed to simultaneously fully temper the glass substrate 2 or merely heat strengthen the substrate 2 depending upon the amount of air pressure applied in a cooling/quench step performed after heating.

Once fired, the glass 2 is moved into the cleaning area were the glass 2 is loaded one by one onto a conveyor and sent through a glass washer where any gas film or contaminants from the tempering process are removed in preparation for the second surface coating 41.

The second surface 4 of the glass substrate 2 has a coating layer 41 to provide opacity to the glass substrate 2 and keep the mounting surface, i.e. wall, hidden from view. The second coating layer 41 may comprise either opaque air-dry epoxy or opaque ultraviolet light cured printable inks. Both are referred to herein as “ink”. These inks can be any color, but are most often white and black.

The second coating layer 41 is applied using a 196 mesh polyester screen with an emulsion coating of 2/2. A seventy durometer squeegee along with an aluminum flood bar is used to transfer the print onto the glass 2 from the screen with a flat bed printer. Alternatively, the second coating layer 41 may be roll coated instead of screen printed as described herein.

After printing full coverage, the glass 2 is again sent down a conveyor oven and dried to the touch with a temperature setting of between 135-190° C. and a conveyor speed of 4.5 meters a minute. When it exits the conveyor oven it is stacked and separated by clothespins until final cross chemical cure is complete 8 hours later. The glass 2 is then packaged according to customer preference.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

I claim:

1. A marker board, comprising:
a glass substrate having a writing surface and a rear surface;
the writing surface having a zinc based ceramic fit layer baked into the writing surface; and
an opaque coating disposed on the rear surface.

2. The marker board according to claim 1, wherein the glass substrate is tempered.

3. The marker board according to claim 1, wherein the ceramic frit comprises zinc borosilicate.

4. The marker board according to claim 1, wherein the ceramic frit is screen printed on the writing surface prior to baking.

5. The marker board according to claim 1, wherein the ceramic frit is roll-coated on the writing surface prior to baking.

6. The marker board according to claim 1, wherein the opaque coating comprises air-dry epoxy ink.

7. The marker board according to claim 1, wherein the opaque coating comprises opaque ultraviolet light cured printable ink.

8. A process for making a marker board, comprising:
a. providing a sheet of glass having a writing surface and a rear surface opposite the writing surface;
b. placing the glass on a screen printing machine writing surface up;
c. screen printing a zinc based ceramic frit coating onto the writing surface using a screen having a mesh thread count of at least 280;
d. heating the glass to bake the fit to the writing surface;
e. applying an opaque ink layer to the rear surface.

9. The process according to claim 8, wherein heating the glass comprises heating the glass to about 600 degrees C.

10. The process according to claim 8, wherein coating, when wet, has a thickness between about 1.0 and about 1.25 mil.

11. The process according to claim 8, wherein the screen printing comprises using an application screen prepared with a 3/3 photosensitive emulsion coat and then placed in a low temperature oven to pre-cure fifteen minutes.

12. The process according to claim 8, wherein the step of applying an opaque ink layer comprises screen printing.

13. A process for making a marker board, comprising:
a. providing a sheet of glass having a writing surface and a rear surface opposite the writing surface;
b. placing the glass on a conveyor, writing surface up;
c. roll coating a miscible having about 60% to about 80%, by weight, of zinc based ceramic frit onto the writing surface;
d. heating the glass to bake the frit to the writing surface;
e. applying an opaque ink layer to the rear surface.

14. The process according to claim 13, wherein heating the glass comprises heating the glass to about 600 degrees C.

15. The process according to claim 13, wherein the roll coating comprises applying a wet laydown thickness of about 0.5 to about 0.75 mil.

16. The process according to claim 13, wherein the miscible has a viscosity of about 15 to about 18 measured on a Brookfield viscometer using a #6 spindle with a 10 to 0.5-ratio speed.

17. The process according to claim 13, wherein the step of roll coating further comprises using a roller grooved to sixty LPI.

18. The process according to claim 13, wherein the step of applying an opaque ink layer comprises screen printing.

19. The process according to claim 18, wherein the opaque ink layer comprises one of air-dry epoxy or ultraviolet light cured ink.
